(19) United States
(12) Patent Application Publication
(10) Pub. No.: US 2008/0036380 A1
(43) Pub. Date: Feb. 14, 2008

(54) PLASMA DISPLAY PANEL AND METHOD OF MANUFACTURING THE SAME

(75) Inventor: Dong Won KANG, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/836,379

(22) Filed: Aug. 9, 2007

(30) Foreign Application Priority Data
Aug. 10, 2006 (KR) 10-2006-0075504

(51) Int. Cl. H01J 17/49; H01J 9/233

(52) U.S. Cl. 313/586; 445/24

(57) ABSTRACT

A plasma display panel is disclosed. The plasma display panel includes a substrate having electrodes and a dielectric layer located on the substrate such that the dielectric layer covers the electrodes. The dielectric layer includes 20 to 60 weight percent of ZnO, 10 to 50 weight percent of B₂O₃, 5 to 30 weight percent of BaO, and 0.5 to 12.0 weight percent of Na₂O.

### CROSS-REFERENCE TO RELATED APPLICATION

This application claims the benefit of Korean Patent Application No. 10-2006-0075504, filed on Aug. 10, 2006, which is hereby incorporated by reference in its entirety.

### BACKGROUND

1. Technical Field

This document relates to a plasma display panel and a method of manufacturing the plasma display panel.

2. Discussion of the Related Art

The advent of multimedia age requires display devices that have higher definition and larger size, and can express colors nearer to natural colors. However, a conventional cathode ray tube (CRT) has limitations in providing a large screen of more than 40 inches. For this reason, a liquid crystal display (LCD), a plasma display panel (PDP), and a projection television have been rapidly developed to be widely applied to the generation of high-definition images.

The plasma display panel is an electronic apparatus that displays an image using plasma discharge. A predetermined voltage is applied to electrodes disposed in a discharge space of the plasma display panel such that plasma discharge occurs between the electrodes, and a fluorescent substance layer, formed in a predetermined pattern, is excited using vacuum ultraviolet rays (VUV), generated during the plasma discharge, whereby an image appears on the plasma display panel.

For the plasma display panel, high strain point glass, such as PD-200, is used as a front substrate and a rear substrate. However, the use of soda-lime glass as the front substrate and the rear substrate is being eagerly considered. This is because the unit cost of the soda-lime glass is approximately ⅙ that of the PD-200, and therefore, the soda-lime glass is very advantageous in terms of unit cost. Consequently, there is much research on the use of the soda-lime glass to reduce the overall cost of plasma display panels.

Meanwhile, a material containing lead (Pb) has been used for a dielectric layer formed on the front substrate. However, the environmental pollution due to Pb has come to the fore, with the result that the restriction of materials containing Pb is being gradually strengthened. Accordingly, there is much research on dielectric compositions for plasma display panels, which can replace Pb containing materials. For example, a bismuth (Bi)-based dielectric composition and a zinc (Zn)-based dielectric composition may be considered.

However, the Bi-based dielectric composition also causes environmental pollution, although different in degree. Furthermore, the Bi-based dielectric composition has a more serious problem in that the unit cost of the Bi-based dielectric composition is very high. On the other hand, the Zn-based dielectric composition is free from environmental pollution. Furthermore, the unit cost of the Zn-based dielectric composition is approximately half that of the Bi-based dielectric composition, and therefore, the Zn-based dielectric composition is advantageous in terms of unit cost. Consequently, there is a high necessity for much more research on the Zn-based dielectric composition.

### SUMMARY

In one general aspect, a plasma display panel includes a substrate having electrodes and a dielectric layer located on the substrate such that the dielectric layer covers the electrodes. The dielectric layer includes 20 to 60 weight percent of ZnO, 10 to 50 weight percent of B₂O₃, 5 to 30 weight percent of BaO, and 0.5 to 12.0 weight percent of Na₂O.

In another general aspect, a method of manufacturing a plasma display panel includes preparing a dielectric layer material, applying the dielectric layer material to a substrate having electrodes, and firing the dielectric layer material. The dielectric layer material includes a mixture of 20 to 60 weight percent of ZnO, 10 to 50 weight percent of B₂O₃, 5 to 30 weight percent of BaO, 0.5 to 12.0 weight percent of Na₂O, a vehicle, and a binder.

In another general aspect, a method of manufacturing a plasma display panel includes preparing a dielectric material, applying the material to a substrate having electrodes, and patterning and firing the material to form a dielectric layer and barrier ribs. The dielectric material includes a mixture of 20 to 60 weight percent of ZnO, 10 to 50 weight percent of B₂O₃, 5 to 30 weight percent of BaO, and 0.5 to 12.0 weight percent of Na₂O, a vehicle, and a binder.

Implementations may include one or more of the following features. For example, the content of Na₂O may be 8.0 to 12.0 weight percent. The B₂O₃/ZnO mole ratio may be 0.8 to 1.0. The dielectric layer may further include less than 10 weight percent of SiO₂ or Al₂O₃. Alternatively or additionally, the dielectric layer may further include a material selected from a group consisting of TiO₂, MgO, BaO, SrO, CaO and P₂O₅. Alternatively or additionally, the dielectric layer may further include a material selected from a group consisting of CoO, CuO, Cr₂O₃, MnO, FeO, and NiO. Alternatively or additionally, the dielectric layer may further include a material selected from a group consisting of CeO₂, Er₂O₃, Nd₂O₃, and Pr₂O₃.

The substrate may include soda-lime glass. The electrodes may include sustain electrodes or address electrodes. The plasma display panel may further include a protect layer formed on the dielectric layer. The plasma display panel may further include barrier ribs formed on the dielectric layer. The barrier ribs may include 20 to 60 weight percent of ZnO, 10 to 50 weight percent of B₂O₃, 5 to 30 weight percent of BaO, and 0.5 to 12.0 weight percent of Na₂O. The color of the dielectric layer may be white.

The dielectric layer material may be prepared by preparing a mixture of 20 to 60 weight percent of ZnO, 10 to 50 weight percent of B₂O₃, 5 to 30 weight percent of BaO, and 0.5 to 12.0 weight percent of Na₂O, melting and cooling the mixture, and pulverizing the cooled mixture to form glass powder. The step of firing the dielectric layer material may be carried out at a temperature of less than 550° C.

Barrier ribs may be formed by preparing a barrier rib material, applying the barrier rib material to the substrate, and firing the barrier rib material. The barrier rib material may include a mixture of 20 to 60 weight percent of ZnO, 10 to 50 weight percent of B₂O₃, 5 to 30 weight percent of BaO, 0.5 to 12.0 weight percent of Na₂O, a vehicle, and a binder.

Other features will be apparent from the following description, including the drawings, and the claims.

### BRIEF DESCRIPTION OF THE DRAWINGS

FIG. 1 is a perspective view illustrating a unit cell of an example plasma display panel; and

FIG. 2 is a flow chart illustrating an example process for forming a dielectric layer for a plasma display panels using a printing method.

### DETAILED DESCRIPTION

Implementations are described with reference to the drawings. In the drawings, the thicknesses of several layers and regions are exaggerated for clear illustration, and therefore, it should be noted that the thickness ratios between the respective layers shown in the drawings are not real. Meanwhile, when it is described that a part, such as a layer, a film, a region, or a plate, is formed or located “on” another part, it must be interpreted that not only the part is directly formed on the other part with the result that the part is brought into direct contact with the other part, but also a further part is interposed between the part and the other part.

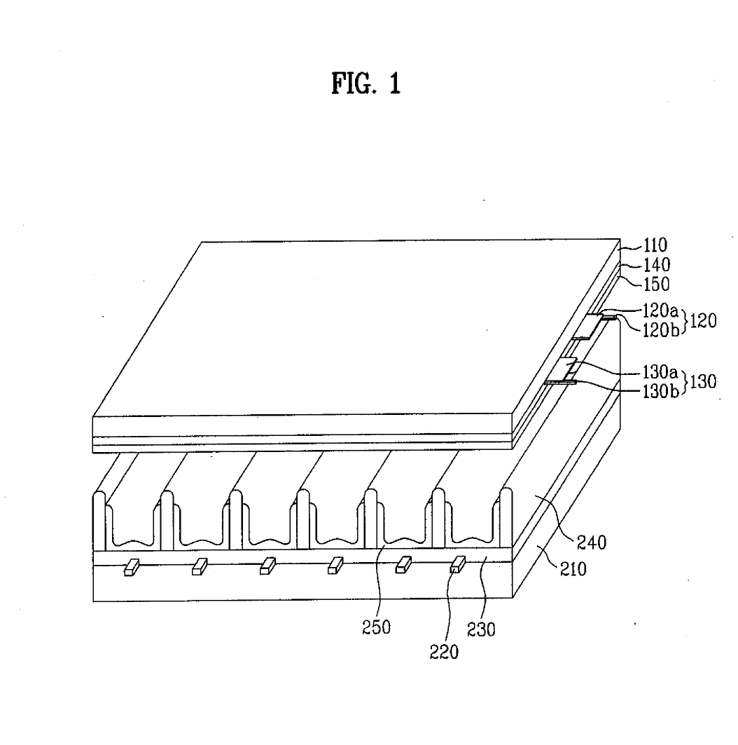

Referring to FIG. 1, an example plasma display panel is constructed in a structure in which display electrodes 120 and 130, including a pair of transparent electrodes 120a and 130a, normally made of indium tin oxide (ITO), and bus electrodes 120b and 130b, normally made of metal, are formed on a front substrate 110 in one direction, and a dielectric layer 140 and an protect layer 150 are sequentially formed on the front surface of the front substrate 110 while covering the display electrodes 120 and 130.

The front substrate 110 is formed by milling and cleaning glass for display substrates. The transparent electrodes 120a and 120b are formed by photoetching ITO or SnO₂, which were previously formed by sputtering, or by lifting off ITO or SnO₂, which were previously formed by chemical vapor deposition (CVD). The bus electrodes 120b and 130b include silver (Ag). In addition, a black matrix may be formed at a sustain electrode pair, that is a pair of display electrodes 120 and 130. The black matrix includes low melting point glass and a black pigment.

On the front substrate 110, which has the transparent electrodes 120a and 120b and the bus electrodes 120b and 130b formed thereon, is formed an upper dielectric layer 140. Here, the upper dielectric layer 140 includes transparent low melting point glass. The detailed composition of the upper dielectric layer 140 will be described below. On the upper dielectric layer 140 is formed a protect layer 150, made of magnesium oxide, for protecting the upper dielectric layer 140 from impact of plus (+) ions, during an electric discharge, and for increasing the emission of secondary ions.

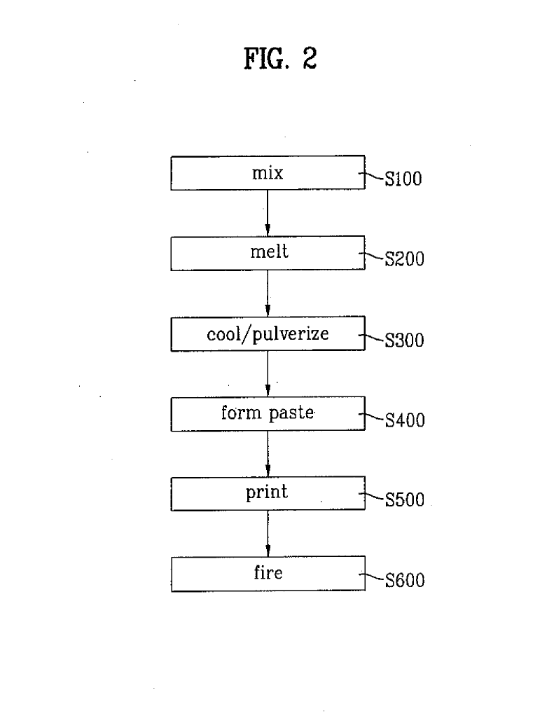

Hereinafter, a process for forming the upper dielectric layer 140 will be described in more detail with reference to FIG. 2. First, 20 to 60 weight percent of ZnO, 10 to 50 weight percent of B₂O₃, 5 to 30 weight percent of BaO, and 0.5 to 12.0 weight percent of Na₂O are mixed with one another (S100). Na₂O serves as a network modifier. In addition, Na₂O increases non-bridging oxygen. Consequently, Na₂O serves to lower the glass transition temperature of a dielectric composition. Preferably, the content of Na₂O is 0.5 to 12.0 weight percent. More preferably, the content of Na₂O is 8.0 to 12.0 weight percent. This is because, when the content of Na₂O is too small, it is difficult to sufficiently lower the glass transition temperature of the dielectric composition, and a coefficient of thermal expansion of the composition is not sufficiently increased to such an extent that the coefficient of thermal expansion of the dielectric composition is matched with a coefficient of thermal expansion of the soda-lime glass substrate. When the content of Na₂O is greater than 12.0 weight percent, on the other hand, the crystallization of the dielectric composition is induced, with the result that the light transmission ratio is considerably lowered, and, in addition, the electrode reactivity of the dielectric layer is increased.

Instead of Na₂O, another alkali metal oxide, for example Li₂O, may be used. However, Li₂O induces the crystallization of the dielectric composition when the content of Li₂O exceeds a predetermined range of content, although a unit amount of Li₂O lowers the glass transition temperature more than the same amount of Na₂O does. Consequently, the allowable content of Li₂O is limited to prevent the crystallization of the dielectric composition. For example, the limited content of Li₂O is approximately 5.0 weight percent. On the other hand, Na₂O has a crystallization inducing property lower than that of Li₂O, with the result that the limited content of Na₂O is approximately 12.0 weight percent, which is much greater than that of Li₂O. Consequently, the allowable maximum content of Na₂O is very high, although Li₂O is more effective in lowering the glass transition temperature than the same amount of Na₂O. As a result, the degree in reduction of the glass transition temperature is very high for Na₂O as compared to Li₂O. In addition, Na₂O increases the coefficient of thermal expansion of the dielectric composition more than Li₂O does, with the result that adjusting the coefficient of thermal expansion of the dielectric composition to match the coefficient of thermal expansion of the soda-lime glass substrate is easier.

On the other hand, the content of ZnO is preferably 20 to 60 weight percent. When the content of ZnO is less than 20 weight percent, the water resistance of the dielectric composition is reduced. When the content of ZnO is greater than 60 weight percent, on the other hand, the glass-forming ability is decreased.

B₂O₃ is provided to increase the glass-forming ability. Preferably, the content of B₂O₃ is 10 to 50 weight percent. B₂O₃ increases the glass transition temperature of the dielectric composition. Consequently, when the content of B₂O₃ is greater than 50 weight percent, it is difficult to lower the glass transition temperature of the dielectric composition to a desired temperature range, with the result that the water resistance of the dielectric composition is reduced. When the content of B₂O₃ is less than 10 weight percent, on the other hand, it is difficult to form the glass of the dielectric composition.

Preferably, the B₂O₃/ZnO mole ratio is approximately 0.8 to 1.3 in order to form stable dielectric glass in the above-specified composition.

BaO, which is an alkaline earth metal oxide, serves as a network modifier, and, in addition, serves to lower the glass transition temperature of the dielectric composition. However, when the content of BaO is excessive, the crystallization of the dielectric composition is induced, with the result that the light transmission ratio of the dielectric layer is seriously lowered. Consequently, the content of BaO may be 5 to 30 weight percent.

In addition, 10 weight percent or less of SiO₂ or Al₂O₃ may be added as an additive to prevent the crystallization of the dielectric composition. Also, a small amount of TiO₂, MgO, SrO, CaO or P₂O₅ may be added to finely adjust the glass transition temperature and the coefficient of thermal expansion of the dielectric composition. The fine adjustment of the coefficient of thermal expansion of the dielectric composition is performed to match the coefficient of thermal expansion of the dielectric composition with the coefficient of thermal expansion of the soda-lime glass substrate, thereby preventing the distortion of the dielectric composition due to the change in temperature. Also, a small amount of a transition element oxide, such as CoO, CuO, Cr₂O₃, MnO, FeO, or NiO, and/or a small amount of a rare earth element oxide, such as CeO₂, Er₂O₃, Nd₂O₃, or Pr₂O₃, may be added to restrain the coloration and electrode reactivity of the dielectric layer.

The dielectric composition mixed as described above is melted in a crucible (S200). Subsequently, the glass of the molten dielectric composition is cooled such that the glass of the dielectric composition is formed into a shape of a thin plate, and the cooled glass of the dielectric composition is pulverized to obtain glass powder (S300). The obtained glass powder is mixed with a vehicle and/or a binder to form a paste (S400). Subsequently, a dielectric layer 140 is formed on the front substrate 110 using the paste by a conventional printing method (S500). Alternatively, a dry film may be manufactured using the paste, and the dry film may be laminated, to form the dielectric layer 140 on the front substrate 110. After the dielectric layer 140 is formed, a process for firing the dielectric layer 140 is carried out, with the result that the formation of the dielectric layer 140 is completed (S600).

When the dielectric composition as described above is used, it is possible to lower the glass transition temperature to less than 550° C., and therefore, it is possible to adjust the temperature necessary for the firing process, i.e., the firing temperature, to less than 550° C. Since the firing temperature is lowered to less than 550° C. by using the dielectric composition, it is possible to avoid the adverse reaction which may occur at the front substrate 110 during the firing process, i.e., the thermal deformation of the soda-lime glass substrate which may occur at a temperature of 550° C. or more.

A protect layer 150 is formed on the dielectric layer 140, using MgO.

On the other hand, address electrodes 220 are formed at one side of a rear substrate 210, such that the address electrodes 220 intersect the display electrodes 120 and 130. A white dielectric layer 230 is formed on the front surface of the rear substrate 210 while covering the address electrodes 220. The white dielectric layer 230, formed on the front surface of the rear substrate 210, may be manufactured using a dielectric composition having the same constituent elements and composition ratios as the dielectric composition for the dielectric layer 140 formed on the front substrate 110 as parent glass. This is to prevent the thermal deformation of the soda-lime glass substrate, which may occur at a temperature of more than 550° C., during a firing process carried out to fire the white dielectric layer 230, after the white dielectric layer 230, formed on the front surface of the rear substrate 210, is formed by a printing method or a film laminating method.

On the white dielectric layer 230 are formed barrier ribs 240, which are disposed between the respective address electrodes 220. By the same reason, the barrier ribs 240 are preferably manufactured using a dielectric composition having the same constituent elements and composition ratios as the dielectric composition for the dielectric layer 140 formed on the front substrate 110 as parent glass. As shown in FIG. 1, the barrier ribs 240 are formed in a stripe-type pattern. Alternatively, the barrier ribs 240 may be formed in a well-type or delta-type pattern.

Between the respective barrier ribs 240 are formed fluorescent substance layers 250 having a red fluorescent substance (R), a green fluorescent substance (G), and a blue fluorescent substance (B).

Discharge cells are provided at the intersections between the address electrodes 220 on the rear substrate 210 and the display electrodes 120 and 130 on the front substrate 110.

Address voltage is applied between the address electrodes 220 and one of the display electrodes 120 or 130 to perform an address discharge such that wall voltage is formed in the cell where an electric discharge occurs. After that, sustain voltage is applied between the pair of display electrodes 120 and 130 to generate a sustain discharge in the cell where the wall voltage is formed. Vacuum ultraviolet rays, generated by the sustain discharge, excite the corresponding fluorescent substances such that the fluorescent substances emit light. As a result, visible rays are emitted through the transparent front substrate 110, and therefore, a picture appears on the plasma display panel.

Hereinafter, various examples of dielectric composition will be described in detail and compared with other examples and comparative examples.

### EXAMPLE 1

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 1/100 the total weight of the mixture, to manufacture a dielectric composition. Specifically, the content of Na₂O in the entire composition was approximately 1.0 weight percent.

### EXAMPLE 2

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 3/100 the total weight of the mixture, to manufacture a dielectric composition. Specifically, the content of Na₂O in the entire composition was approximately 2.9 weight percent.

### EXAMPLE 3

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 5/100 the total weight of the mixture, to manufacture a dielectric composition. Specifically, the content of Na₂O in the entire composition was approximately 4.8 weight percent.

### EXAMPLE 4

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 7/100 the total weight of the mixture, to manufacture a dielectric composition. Specifically, the content of Na₂O in the entire composition was approximately 6.5 weight percent.

### EXAMPLE 5

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 9/100 the total weight of the mixture, to manufacture a dielectric composition. Specifically, the content of Na₂O in the entire composition was approximately 8.3 weight percent.

### EXAMPLE 6

ZnO, B₂O₃, BaO, and SiO₂+Al₂O₃ were mixed, such that a weight ratio of ZnO, B₂O₃, BaO, and SiO₂+Al₂O₃ was 45:40:11:4, and Na₂O was added to the mixture, such that the amount of Na₂O was equivalent to 11/100 the total weight of the mixture, to manufacture a dielectric composition. Specifically, the content of Na₂O in the entire composition was approximately 9.9 weight percent.

### COMPARATIVE EXAMPLE 1

ZnO, B₂O₃, BaO, and SiO₂+Al₂O₃ were mixed, such that a weight ratio of ZnO, B₂O₃, BaO, and SiO₂+Al₂O₃ was 45:40:11:4, and Li₂O was added to the mixture, such that the amount of Li₂O was equivalent to 6/100 the total weight of the mixture, to manufacture a dielectric composition. Specifically, the content of Li₂O in the entire composition was approximately 5.7 weight percent.

Firing temperatures, dielectric constants, and coefficients of thermal expansion of the respective samples manufactured according to Examples 1 to 6 and Comparative example 1 were measured. The measurement results are indicated in Table 1 below.

TABLE 1

| | | | | | | | Firing | | coefficient |
|---|---|---|---|---|---|---|---|---|---|
| | | | | | | | temperature | Dielectric | of thermal |
| | ZnO | B₂O₃ | BaO | SiO₂ + Al₂O₃ | Na₂O | Li₂O | (° C.) | constant | expansion |
| Example 1 | 45 | 40 | 11 | 4 | 1 | — | <590 | >8 | <85 |
| Example 2 | 45 | 40 | 11 | 4 | 3 | — | <580 | >8 | <85 |
| Example 3 | 45 | 40 | 11 | 4 | 5 | — | <570 | >8 | <85 |
| Example 4 | 45 | 40 | 11 | 4 | 7 | — | <570 | >8 | <85 |
| Example 5 | 45 | 40 | 11 | 4 | 9 | — | <560 | >8 | <90 |
| Example 6 | 45 | 40 | 11 | 4 | 11 | — | <550 | >8 | <95 |
| Comparative | 45 | 40 | 11 | 4 | — | 6 | crystallized | — | <85 |
| example 1 | | | | | | | | | |

As can be seen from Table 1 above, the firing temperatures of the dielectric composition manufactured according to Examples 1 to 6 were lowered in proportion to the amount of Na₂O added. Specifically, the firing temperatures of the samples according to examples 1-6 were less than 590° C. Especially, the firing temperatures of the samples manufactured according to Examples 5 and 6 were less than 560° C. Consequently, the thermal deformation of the soda-lime glass substrate was very minor. Furthermore, for Examples 5 and 6, the coefficients of thermal expansion of the compositions were increased such that the coefficients of thermal expansion of the compositions were approximate to the coefficient of thermal expansion of the soda-lime glass substrate. Consequently, the distortion due to the difference in coefficients of thermal expansion between the dielectric layer and the soda-lime glass substrate can be prevented.

As can be seen from the above experiments, it was possible to lower the glass transition temperature or the firing temperature of the dielectric composition in proportion to the content of Na₂O added. Especially, when more than 8.0 weight percent of Na₂O was added, the thermal deformation of the soda-lime glass substrate, during the firing process, was very minor. In addition, the coefficient of thermal expansion of the dielectric composition was increased.

As can be seen from Comparative example 1 using Li₂O instead of Na₂O, the dielectric composition was crystallized even when the content of Li₂O was 5.7 weight percent. As can be seen from Example 6, on the other hand, it was possible to lower the firing temperature of the dielectric composition, without the crystallization of the dielectric composition, even when the content of Na₂O was 9.9 weight percent. Consequently, it can be clearly seen that the maximum content of Na₂O addable to the dielectric composition is much greater than the maximum content of Li₂O addable to the dielectric composition. Although not specified in connection with the above-described examples, the maximum content of Na₂O, which was capable of lowering the firing temperature of the dielectric composition without the crystallization of the dielectric composition, was approximately 12.0 weight percent.

As described above, it is possible to lower the firing temperature of a Zn-based dielectric composition, which generally requires a high firing temperature, without the crystallization of the dielectric composition, by adding an appropriate amount of Na₂O to the dielectric composition, thereby preventing the thermal deformation of the soda-lime glass substrate during the firing process.

Also, the dielectric composition has a coefficient of thermal expansion that can be matched with a coefficient of thermal expansion of the soda-lime glass substrate, and therefore, it is possible to prevent distortion due to the difference in coefficients of thermal expansion between the dielectric composition and the soda-lime glass substrate.

As a result, it is possible to use both the soda-lime glass substrate and Zn-based dielectric composition, which are low in unit cost, thereby reducing the overall cost of plasma display panels. Furthermore, Pb is not used, and therefore, the dielectric composition is free from environmental restriction.

Hereinafter, an example method of manufacturing a plasma display panel will be described.

First, transparent electrodes and bus electrodes are formed on a front substrate. The front substrate is manufactured by milling and cleaning glass for display substrates or soda-lime glass. The transparent electrodes are formed by photoetching ITO or SnO₂, which were previously formed by sputtering, or by lifting off ITO or SnO₂, which were previously formed by CVD. The bus electrodes are formed by screen printing silver (Ag) or applying photosensitive silver paste. In addition, a black matrix may be formed at a sustain electrode pair. The black matrix may be formed by screen printing low melting point glass and a black pigment or applying photosensitive low melting point glass and black pigment paste.

Subsequently, an upper dielectric layer is formed on the front substrate, covering the transparent electrodes and the bus electrodes formed thereon. Here, the upper dielectric layer is formed by stacking the dielectric composition as described above using a screen printing method, a coating method, or a green sheet laminating method.

Subsequently, a protect layer is deposited on the upper dielectric layer. Here, the protect layer may be formed by electron beam depositing, sputtering, or ion plating magnesium oxide.

Address electrodes are formed on a rear substrate. Here, the rear substrate is manufactured by milling and cleaning glass for display substrates or soda-lime glass. The address electrodes are formed by screen printing silver (Ag), applying photosensitive silver paste, or sputtering and photoetching silver. After that, a lower dielectric layer is formed on the rear substrate, covering the address electrodes formed thereon. The lower dielectric layer is formed by screen printing or green sheet laminating the dielectric composition as described above. Here, the color of the lower dielectric layer may be white increase the brightness of the plasma display panel.

Subsequently, barrier ribs are formed such that discharge cells are divided by the barrier ribs. At this time, a barrier rib material includes parent glass and filler. The parent glass may include PbO, SiO₂, B₂O₃, and Al₂O₃, and the filler may include TiO₂ and Al₂O₃. Also, the barrier rib material may include a dielectric substance material having the above-described Na₂O.

Subsequently, a black top material is applied to the barrier rib material. Here, the black top material includes a solvent, inorganic powder, and an additive. The inorganic powder includes glass frit and a black pigment. After that, the barrier rib material and the black top material are patterned to form barrier ribs and a black top.

The patterning process is performed by masking, exposing, and developing the barrier rib material and the black top material. Specifically, when the barrier rib material and the black top material are exposed, a mask is located to block the portions of the barrier rib material and the black top material corresponding to the address electrodes. Only the portions of the barrier rib material and the black top material to which light is irradiated are left, after the developing and firing processes, to form the barrier ribs and the black top. When a photoresist component is contained in the black top material, the patterning of the barrier rib material and the black top material is easily performed. Also, when the barrier rib material and the black top material are simultaneously fired, the coupling force between the parent glass in the barrier rib material and the inorganic powder in the black top material is increased, which improves the durability.

Subsequently, fluorescent substances are applied on the lower dielectric layer and the sides of the barrier ribs. A red fluorescent substance (R), a green fluorescent substance (G), and a blue fluorescent substance (B) are successively applied to the respective discharge cells. The fluorescent substances are applied by a screen printing method or a photosensitive paste applying method.

Subsequently, an upper panel is coupled to a lower panel, while the barrier ribs are disposed between the upper panel and the lower panel, the panel assembly is sealed, impurities are discharged from the panel assembly, and a discharge gas is injected into the panel assembly.

In another example method of manufacturing a plasma display panel, the lower dielectric layer material and the barrier rib material may be manufactured using a single green sheet. Here, the green sheet may have a first layer, including the lower dielectric layer material, and a second layer, including the barrier rib material. The same materials used in the above example method may be used for the dielectric substance material and the barrier rib material. The second layer must be patterned to form barrier ribs. Consequently, the second layer includes a photoresist component.

The green sheet is stacked on the rear substrate, covering the address electrodes formed thereon. After that, the green sheet is exposed and developed. At this time, the second layer is patterned to form barrier ribs. Here, the lower dielectric layer and the barrier ribs are fired at a temperature of less than 550° C. Consequently, the coupling force between the lower dielectric layer and the barrier ribs is increased, which improves durability.

Other implementations are within the scope of the following claims.

What is claimed is:

1. A plasma display panel comprising:
a substrate having electrodes; and
a dielectric layer located on the substrate such that the dielectric layer covers the electrodes, wherein
the dielectric layer includes 20 to 60 weight percent of ZnO, 10 to 50 weight percent of B₂O₃, 5 to 30 weight percent of BaO, and 0.5 to 12.0 weight percent of Na₂O.

2. The plasma display panel according to claim 1, wherein, a content of Na₂O is 8.0 to 12.0 weight percent.

3. The plasma display panel according to claim 1, wherein a B₂O₃/ZnO mole ratio is 0.8 to 1.0.

4. The plasma display panel according to claim 1, wherein the dielectric layer further includes less than 10 weight percent of SiO₂ or Al₂O₃.

5. The plasma display panel according to claim 1, wherein the dielectric layer further includes a material selected from a group consisting of TiO₂, MgO, BaO, SrO, CaO and P₂O₅.

6. The plasma display panel according to claim 1, wherein the dielectric layer further includes a material selected from a group consisting of CoO, CuO, Cr₂O₃, MnO, FeO, and NiO.

7. The plasma display panel according to claim 1, wherein the dielectric layer further includes a material selected from a group consisting of CeO₂, Er₂O₃, Nd₂O₃, and Pr₂O₃.

8. The plasma display panel according to claim 1, wherein the substrate comprises soda-lime glass.

9. The plasma display panel according to claim 1, further comprising a protect layer placed on the dielectric layer.

10. The plasma display panel according to claim 1, wherein the electrodes include sustain electrodes.

11. The plasma display panel according to claim 1, wherein the address includes address electrodes.

12. The plasma display panel accordingly to claim 1, further comprising barrier ribs formed on the dielectric layer, the barrier ribs including 20 to 60 weight percent of ZnO, 10 to 50 weight percent of B₂O₃, 5 to 30 weight percent of BaO, and 0.5 to 12.0 weight percent of Na₂O.

13. The plasma display panel according to claim 12, wherein a color of the dielectric layer is white.

14. A method of manufacturing a plasma display panel, comprising:
preparing a dielectric layer material including a mixture of 20 to 60 weight percent of ZnO, 10 to 50 weight percent of B₂O₃, 5 to 30 weight percent of BaO, 0.5 to 12.0 weight percent of Na₂O, a vehicle, and a binder;
applying the dielectric layer material to a substrate having electrodes; and
firing the dielectric layer material.

15. The method according to claim 14, wherein the substrate comprises soda-lime glass.

16. The method according to claim 14, wherein preparing the dielectric layer material comprises:
preparing a mixture of 20 to 60 weight percent of ZnO, 10 to 50 weight percent of B₂O₃, 5 to 30 weight percent of BaO, and 0.5 to 12.0 weight percent of Na₂O;
melting and cooling the mixture; and
pulverizing the cooled mixture to form glass powder.

17. The method according to claim 14, wherein the step of firing the dielectric layer material is carried out at a temperature of less than 550° C.

18. The method according to claim 14, further comprising:
forming a protect layer on the dielectric layer.

19. The method according to claim 14, further comprising:
preparing a barrier rib material including a mixture of 20 to 60 weight percent of ZnO, 10 to 50 weight percent of B₂O₃, 5 to 30 weight percent of BaO, 0.5 to 12.0 weight percent of Na₂O, a vehicle, and a binder;
applying the barrier rib material to the substrate; and
firing the barrier rib material.

20. A method of manufacturing a plasma display panel, comprising:
preparing a material including a mixture of 20 to 60 weight percent of ZnO, 10 to 50 weight percent of B₂O₃, 5 to 30 weight percent of BaO, and 0.5 to 12.0 weight percent of Na₂O, a vehicle, and a binder;
applying the material to a substrate having electrodes; and
patterning and firing the material to form a dielectric layer and barrier ribs.

21. The method according to claim 20, wherein the material includes a first layer for forming the dielectric layer and a second layer for forming the barrier ribs.

22. The method according to claim 21, wherein the step of patterning the material includes exposing and developing the second layer.
